(19) United States
(12) Patent Application Publication
(10) Pub. No.: US 2025/0061485 A1
(43) Pub. Date: Feb. 20, 2025

(54) SYSTEM AND METHODS FOR MITIGATING FRAUD IN REAL TIME USING FEEDBACK

(71) Applicant: TrafficGuard Pty Ltd, Bentley (AU)

(72) Inventors: Luke Anthony James Taylor, Cloverdale (AU); Raigon Jolly, Thornlie (AU); André Bonkowski, Lynwood (AU); Andrey Kostenko, East Perth (AU)

(21) Appl. No.: 18/937,016

(22) Filed: Nov. 4, 2024

(30) Foreign Application Priority Data
Apr. 18, 2018 (AU) 2018901298

(51) Int. Cl. G06Q 30/0241

(52) U.S. Cl. CPC G06Q 30/0248

(57) ABSTRACT

The embodiments disclose a method for mitigating fraud, including generating input data on a local device of a selected advertisement, transmitting the input data of the local device to the advertiser server with one advertisement being selected, analyzing and comparing current attributes of a source of the input data with known attributes of known sources based on registered profile information of the source to determine if certain behavioral anomalies exists, using comparisons of the current and known attributes to detect a malicious source or a legitimate source based on an analysis and comparison of the current and the known attributes, blocking the selectable advertisement to prevent access to the selectable advertisement on the local device of at least one malicious source and allowing the selectable advertisement to be transmitted to the advertiser server to allow access to the selectable advertisement on the local device of at least one legitimate source.

### CROSS-REFERENCE TO RELATED APPLICATIONS

This patent application is a Continuation-in-part and claims priority to United States patent application entitled: “System and Methods for Mitigating Fraud in Real Time Using Feedback”, U.S. Ser. No. 17/048,359 filed on Apr. 17, 2019 filed by Luke Anthony James Taylor, which is a continuation-in-part of PCT/AU2019/050343 Foreign patent application entitled: “System and Methods for Mitigating Fraud in Real Time Using Feedback”, Australian Serial Number 2018901298 filed on Apr. 18, 2018 filed by Luke Anthony James Taylor, all the patent applications being incorporated herein by reference.

### BACKGROUND

Invalid traffic refers to any non-genuine click activity on a paid link. Non-genuine clicks can include fraudulent clicks purposely made to artificially inflate an advertiser's costs or a publisher's earnings. Detecting fraudulent clicks uses a great deal of information gathered that is organized to quickly identify invalid traffic. The gathered data is organized using databases and file management systems to allow rapid distinctions between valid traffic and invalid traffic. The gathered data organization is key to successfully preventing valueless clicks and impressions. A well-structured database and file management system is needed to protect the advertiser from fraudulent invalid traffic.

### A BRIEF SUMMARY OF THE INVENTION

The present invention is a database and file management for fraud protection and prevention of online advertisers. Although the present invention will be described with particular reference to mitigating, and more specifically, to detecting and preventing fraud comprising invalid traffic on ads in a mobile environment, it will be appreciated that implementations of the invention may be used to furnish protection in respect of other types of fraud or deception blocking invalid traffic in real-time.

A database and file management fraud protection management system receives clicks from a fraudulent server used to produce fraudulent and invalid clicks purposely made to artificially inflate an advertiser's costs. Also, the database and file management fraud protection management system receives clicks from a valid user on, for example, a banner ad for a product of interest. The invalid and valid clicks are received in a control server for real-time analysis and detection of the click traffic. The control server gathers click attributes data from each click's electronic signature. The gathered data is processed with a processor used to match click attributes data with blacklisted click attributes to detect invalid traffic (IVT). In one instance, the click from the fraudulent server is blocked in real-time as a detected IVT fraudulent click. The blacklist IVT blocking click attributes database is updated with the current fraudulent server click attributes. The click attributes are organized in the blacklist IVT blocking click attributes database using a file management system to allow rapid comparisons with incoming click traffic to detect IVTs in real-time. The click from the valid user gathered click attributes is compared to the detected as valid traffic. The valid user click is transmitted to an advertiser web server as valid traffic in real-time.

### BRIEF DESCRIPTION OF THE DRAWINGS

FIG. 1 shows for illustrative purposes only an example of a database and file management fraud protection management system of one embodiment.

FIG. 2 shows for illustrative purposes only an example of click attributes gathered data of one embodiment.

FIG. 3 shows for illustrative purposes only an example of detected invalid traffic of one embodiment.

FIG. 4 shows for illustrative purposes only an example of three complementary facets of one embodiment.

FIG. 5 shows a block diagram of an overview flow chart of a valid traffic identification of one embodiment.

FIG. 6 shows a block diagram of an overview flow chart of an invalid traffic detection of one embodiment.

FIG. 7 shows a block diagram of an overview of a control server structure of one embodiment.

FIG. 8 shows for illustrative purposes only an example of an analysis of click data for blocking of one embodiment.

FIG. 9 shows for illustrative purposes only an example of advertiser clients of one embodiment.

FIG. 10 shows for illustrative purposes only an example of invalid traffic detection facets of one embodiment.

FIG. 11 shows for illustrative purposes only an example of four major sub-systems of one embodiment.

FIG. 12 shows a block diagram of an overview of the prevention subsystem of one embodiment.

FIG. 13 shows a block diagram of an overview of a partner status workflow of one embodiment.

FIG. 14 shows for illustrative purposes only an example of active campaign traffic of one embodiment.

FIG. 15 shows for illustrative purposes only an example of a system traffic-blocking diagram of one embodiment.

FIG. 16 shows for illustrative purposes only an example of blacklist rules classification of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview

It should be noted that the descriptions that follow, for example, in terms of a database and file management fraud protection management system are described for illustrative purposes and the underlying system can apply to any number and multiple types of internet traffic. In one embodiment of the present invention, the database and file management fraud protection management system can be configured using at least one server. The database and file management fraud protection management system can be configured to include at least one blacklist database and can be configured to include internet traffic detection in real-time using the present invention.

In one embodiment of the present invention, a distributed database and file management system is used for fraud protection and prevention for online advertisers. The present invention includes mitigating, detecting and preventing fraudulent online traffic usage of Internet advertisements for computers and mobile devices. It will be appreciated that implementations of the invention may be used to furnish protection in respect of other types of fraud or deception blocking invalid traffic in real-time.

In one embodiment, the present invention includes a database and file management fraud protection management system that receives clicks from numerous different sources. In one embodiment, the system receives robot generated fraudulent invalid clicks from a fraudulent server for clicking on an advertiser's ad with the intention of artificially inflating the advertiser's costs. They system also receives a valid click from a user using a computer desiring to click on a banner ad for a product of interest.

Both the invalid and valid clicks are received by a control server for real-time analysis and detection of the click traffic. The control server gathers click attributes data from each click's electronic signature and matches click attributes data with blacklisted click attributes to detect invalid traffic (IVT). In one embodiment, the click from the fraudulent server is blocked in real-time as a detected IVT fraudulent click. The blacklist IVT blocking click attributes database is updated with the current fraudulent server click attributes. The click attributes are organized in the blacklist IVT blocking click attributes database using a file management system to allow rapid comparisons with incoming click traffic to detect IVTs in real-time. The click from the valid user gathered click attributes is compared to the detected as valid traffic. The valid user click is transmitted to an advertiser web server as valid traffic in real-time.

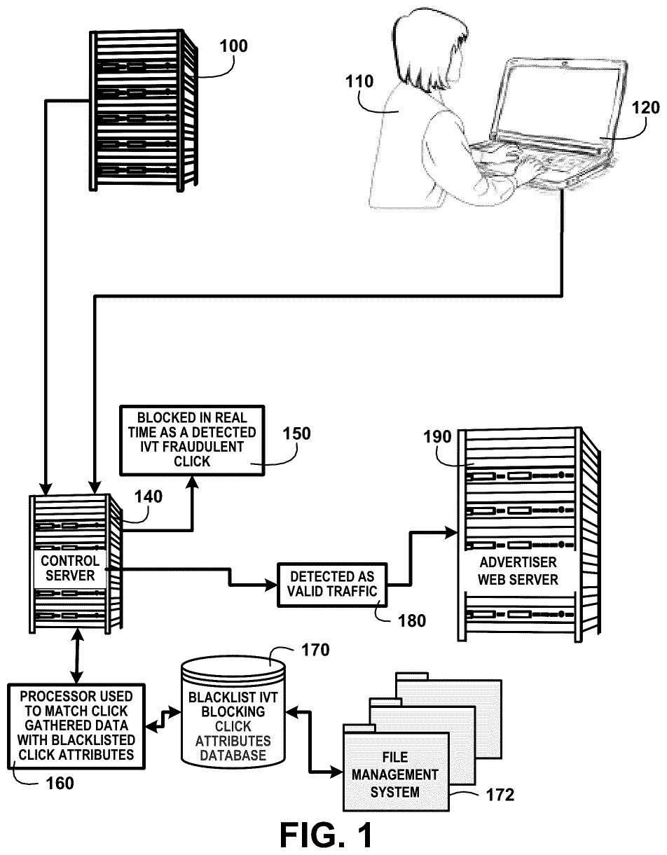

FIG. 1 shows for illustrative purposes only an example of a database and file management fraud protection management system of one embodiment. FIG. 1 shows a fraudulent server 100 used to produce fraudulent clicks purposely made to artificially inflate an advertiser's costs. FIG. 1 shows a valid user 110 using a computer 120 to click on, for example, a banner ad for a product of interest. The invalid and valid clicks are received in a control server 140 for real-time analysis and detection of the click traffic. The control server 140 gathers click attributes data from each click's electronic signature. The gathered data is processed with a processor used to match click attributes data with blacklisted click attributes 160 to detect invalid traffic (IVT). In one instance, the click from the fraudulent server 100 is blocked in real-time as a detected IVT fraudulent click 150. The blacklist IVT blocking click attributes database 170 is updated with the current fraudulent server 100 click attributes. The click attributes are organized in the blacklist IVT blocking click attributes database 170 using a file management system 172 to allow rapid comparisons with incoming click traffic to detect IVTs in real-time. The click from the valid user 110 gathered click attributes is compared to the detected as valid traffic 180. The valid user 110 click is transmitted to an advertiser web server 190 as valid traffic in real time of one embodiment.

### DETAILED DESCRIPTION

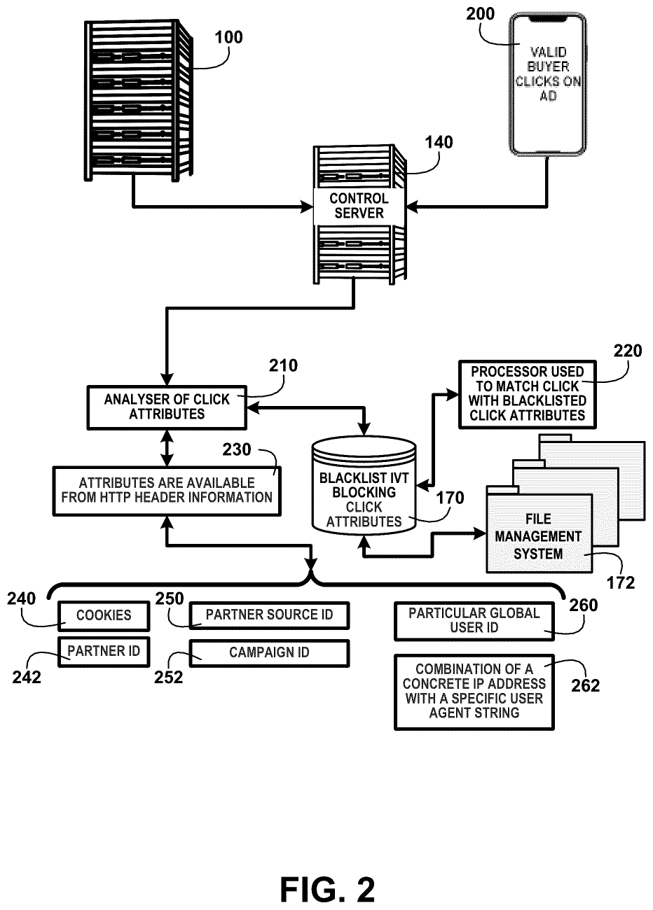

FIG. 2 shows for illustrative purposes only an example of click attributes gathered data of one embodiment. FIG. 2 shows the fraudulent server 100 clicking on an ad and a user mobile device valid buyer clicks on ad 200. Both clicks are transmitted to the control server 140. An analyzer of click attributes 210 receives the clicks and accesses the blacklist IVT blocking click attributes 170 database and file management system 172. The analyzer of click attributes 210 has a processor used to match click with blacklisted click attributes 220. The attributes are available from http header information 230 including, for example, cookies 240, partner ID 242, partner source ID 250, campaign ID 252, particular global user ID 260, and a combination of a concrete IP address with a specific user agent string 262. The click attributes analyzed are stored in the blacklist IVT blocking click attributes 170 databases and organized using the file management system 172. The stored click attributes are used to identify and detect future clicks by the same entities to perform detection of invalid traffic and fraudulent clicks for real-time detection and blocking as determined of one embodiment.

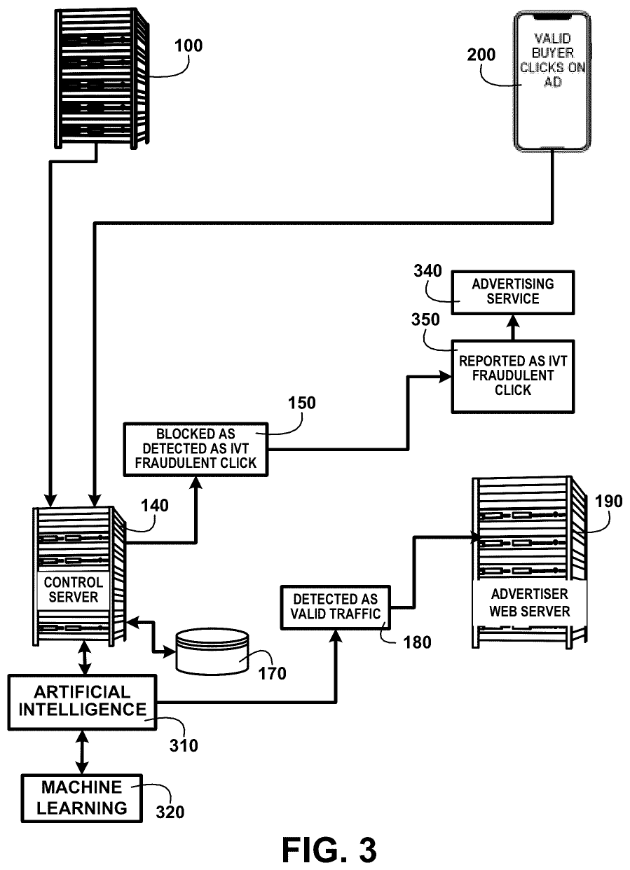

FIG. 3 shows for illustrative purposes only an example of detected invalid traffic of one embodiment. FIG. 3 shows the fraudulent server 100 and a user mobile device valid buyer clicks on ad 200. Both clicks are received by the control server 140. The blacklist IVT blocking click attributes 170 database is used by the control server 140 to identify the fraudulent server 100. The fraudulent server 100 click is blocked as detected as an IVT fraudulent click 150 and reported as an IVT fraudulent click 350 to the advertising service 340. The control server 140 artificial intelligence 310 and machine learning 320 devices are used to build the real-time detection capability of the blacklist IVT blocking click attributes 170 database. The user mobile device valid buyer clicks on ad 200 is detected as valid traffic 180 and sent to the advertiser web server 190 of one embodiment.

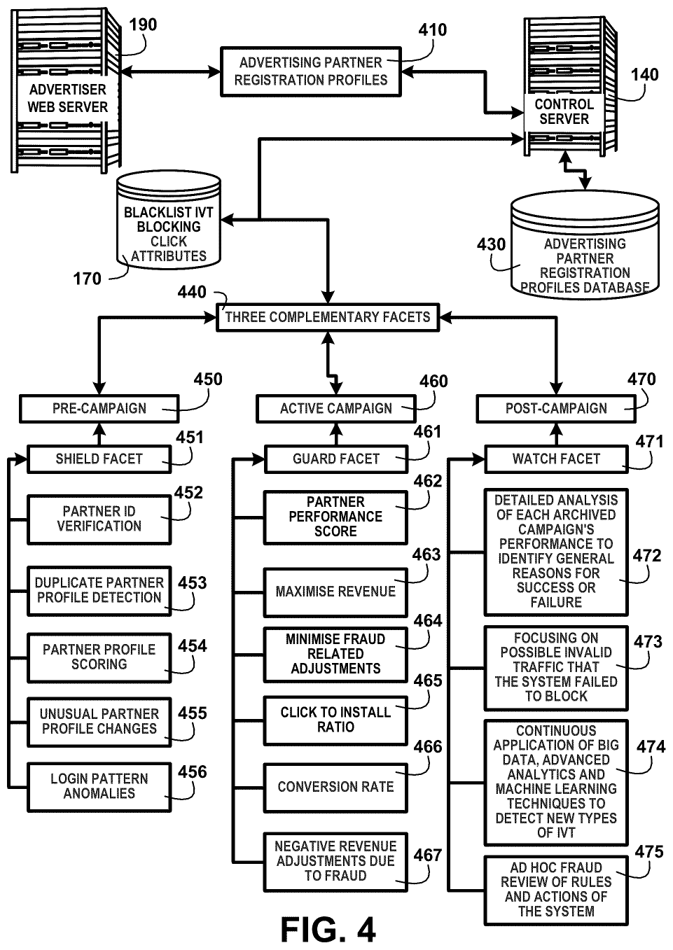

FIG. 4 shows for illustrative purposes only an example of three complementary facets of one embodiment. FIG. 4 shows an advertiser using the advertiser web server 190 for sending advertising partner registration profiles 410 to the control server 140. The advertising partner registration profiles 410 are stored in an advertising partner registration profiles database 430. Some of the profile data is also stored in the blacklist IVT blocking click attributes 170 database. The advertising partner registration profiles database 430 provides data for three complementary facets 440 to create data for use in identifying the advertising partner in the fraudulent traffic detections. A pre-campaign 450 shield facet 451 analyzes the partner ID verification 452, checks for duplicate partner profile detection 453, determines a partner profile scoring 454, checks for unusual partner profile changes 455, and also checks for any login pattern anomalies 456.

An active campaign 460 guard facet 461 analyzes the profile data to generate a partner performance score 462, Key Performance Indicators (KPI)s to determine steps to maximize revenue 463 and minimize fraud-related adjustments 464, measures a click-to-install ratio 465, a conversion rate 466 and negative revenue adjustments due to fraud 467. A post-campaign 470 watch facet 471 performs a detailed analysis of each archived campaign's performance to identify general reasons for success or failure 472. The detailed analysis is focusing on possible invalid traffic that the system failed to block 473. The detailed analysis further analyzes a continuous application of big data, advanced analytics, and machine learning techniques to detect new types of IVT 474 encountered. An ad hoc fraud review of rules and actions of the system 475 to prevent future fraudulent traffic of one embodiment.

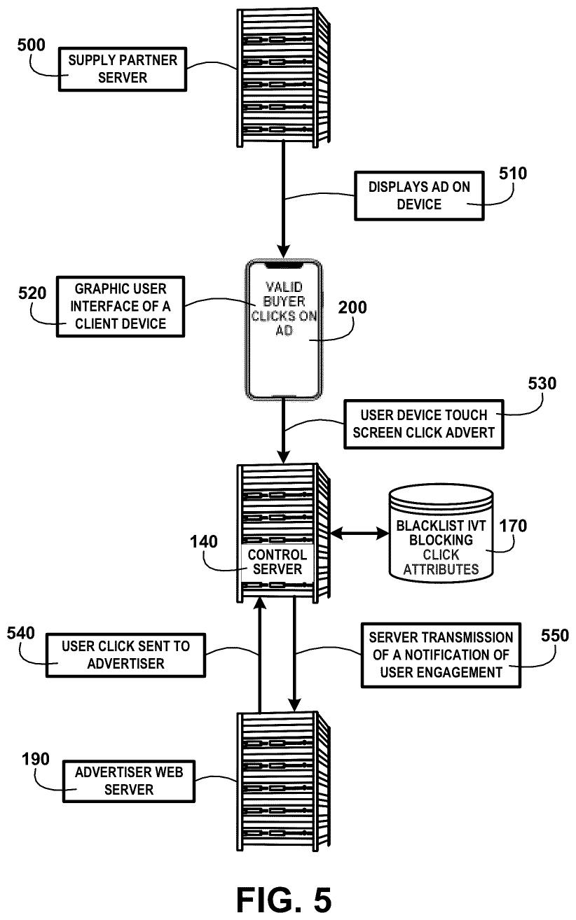

FIG. 5 shows a block diagram of an overview flow chart of a valid traffic identification of one embodiment. FIG. 5 shows a supply partner server 500 that displays an ad on device 510. The graphic user interface of a client device 520. The user's mobile device valid buyer clicks on ad 200 with a user device touch screen click advert 530. The control server 140 receives the click and processes the click using the blacklist IVT blocking click attributes 170 database. The server transmission of a notification of user engagement 550 and user click sent to advertiser 540 to process the user ad click on the advertiser web server 190 of one embodiment.

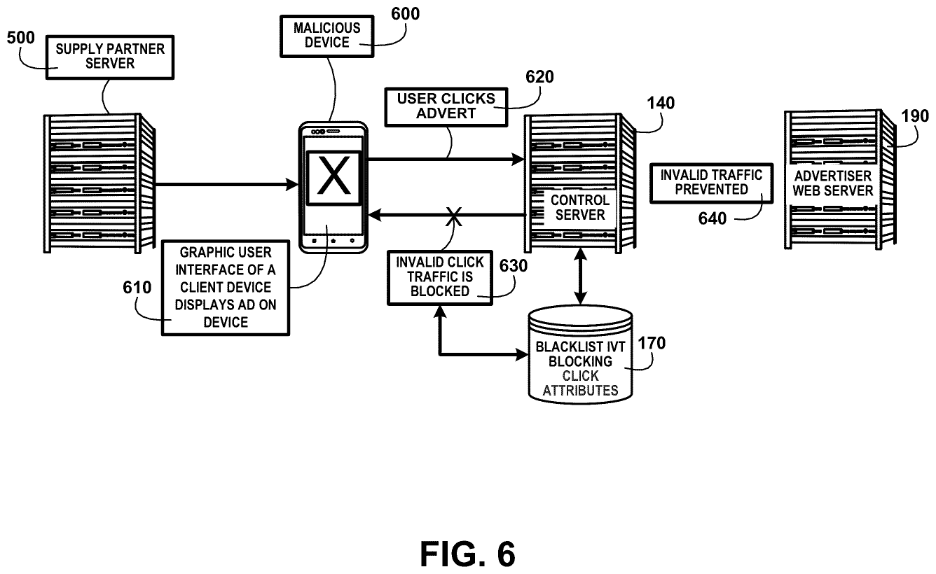

FIG. 6 shows a block diagram of an overview flow chart of an invalid traffic detection of one embodiment. FIG. 6 shows a supply partner server 500 and is clicked with a malicious device 600. The ad is displayed on the graphic user interface of a client device and displays an ad on the device 610. The user clicks advert 620 and is directed to the control server 140 for comparison with the blacklist IVT blocking click attributes 170 database. The invalid click traffic is blocked 630 based on detection from the blacklist IVT blocking click attributes 170 database. In this instance the invalid traffic prevented 640 is not sent to the advertiser web server 190 and the advertiser is saved the cost of the fraudulent traffic of one embodiment.

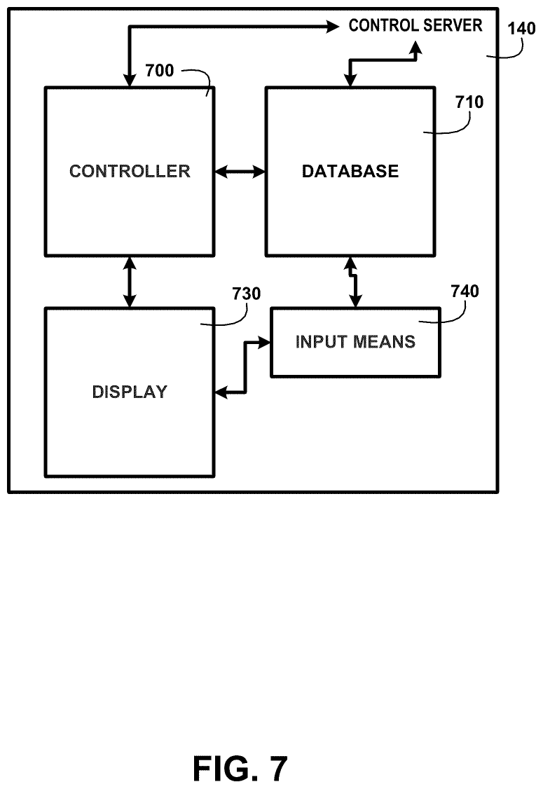

FIG. 7 shows a block diagram of an overview of a control server structure of one embodiment. FIG. 7 shows the control server 140 structure includes in one embodiment a controller 700, database 710, display 730, and input means 740. In another embodiment, the database and file management fraud protection management system may include more than one control server, including a remote control server that all work in unison to prevent fraudulent traffic. The control server 140 may include multiple databases to store multiple types of data. The control server 140 may include multiple file management systems to classify multiple types of data. For example, in one embodiment the database may store the blacklist IVT blocking click attributes data.

In another embodiment, the control server 140 may include an advertising partner registration profiles database. The differences in the data may use different classifications that can be provided using different file management systems. The blocking of clicks may be stored on a separate database from the validation of clicks to, for example, speed queries for the detection subsystem.

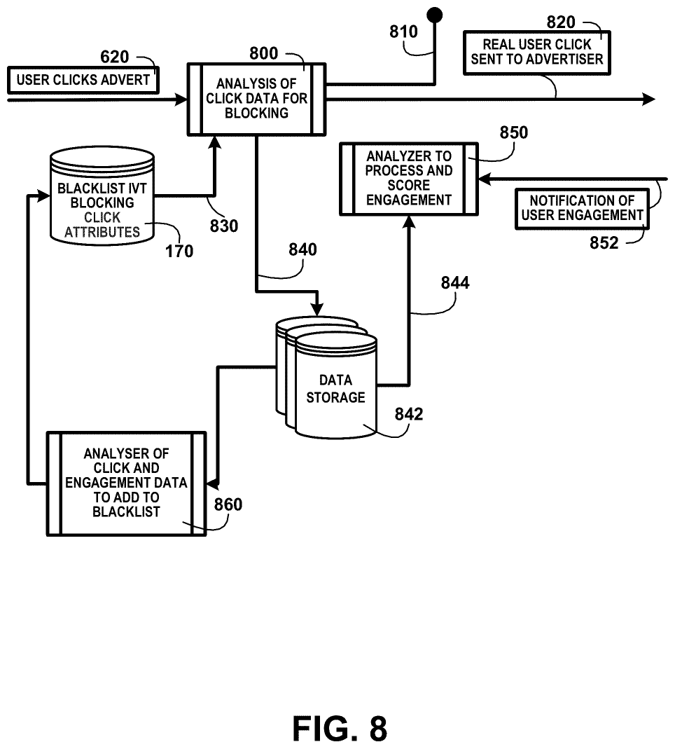

FIG. 8 shows for illustrative purposes only an example of an analysis of click data for blocking of one embodiment. FIG. 8 shows in one embodiment the analytics steps used in the database and file management fraud protection management system. A user clicks advert 620 which activates an analysis of click data for blocking 800. An analyzer performs an analysis of click data sent to data storage 840. The click data is recorded in data storage 842 databases. A notification of user engagement 852 with the click is prepared. An analyzer to process and score engagement 850 is used to determine if the click is classified as valid or invalid. The notification sent to data storage 844 is available in real-time from the data storage 842 and the click should be valid. The analyzer of click and engagement data to add to blacklist 860 is recorded for the present click. The blacklist IVT blocking click attributes 170 databases store the results for the present click. The detection results transmitted 830 determine the click block not used 810 and the notification in the data storage 842 is retrieved with the real user click sent to advertiser 820 of one embodiment.

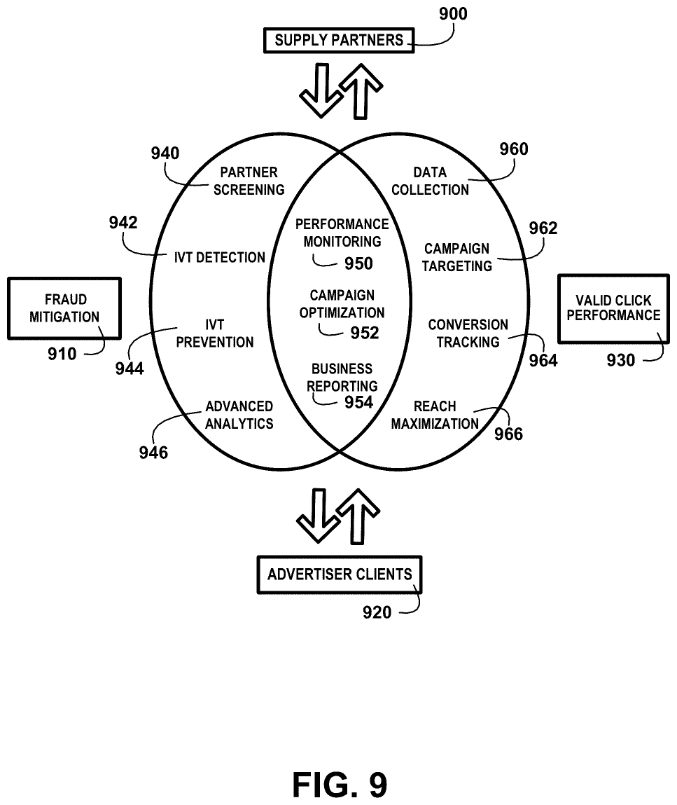

FIG. 9 shows for illustrative purposes only an example of advertiser clients of one embodiment. FIG. 9 shows the factors that are involved in the database and file management fraud protection management system invalid traffic operations. The operations involve the supply partners 900, fraud mitigation 910, advertiser clients 920, and valid click performance 930. The system controls partner screening 940, IVT detection 942, IVT prevention 944, and advanced analytics 946. Another group of steps includes performance monitoring 950, campaign optimization 952, and business reporting 954. The database and file management includes data collection 960, campaign targeting 962, and conversion tracking 964 to reach maximization 966 of the fraud prevention and reduction in financial losses due to invalid clicks of one embodiment.

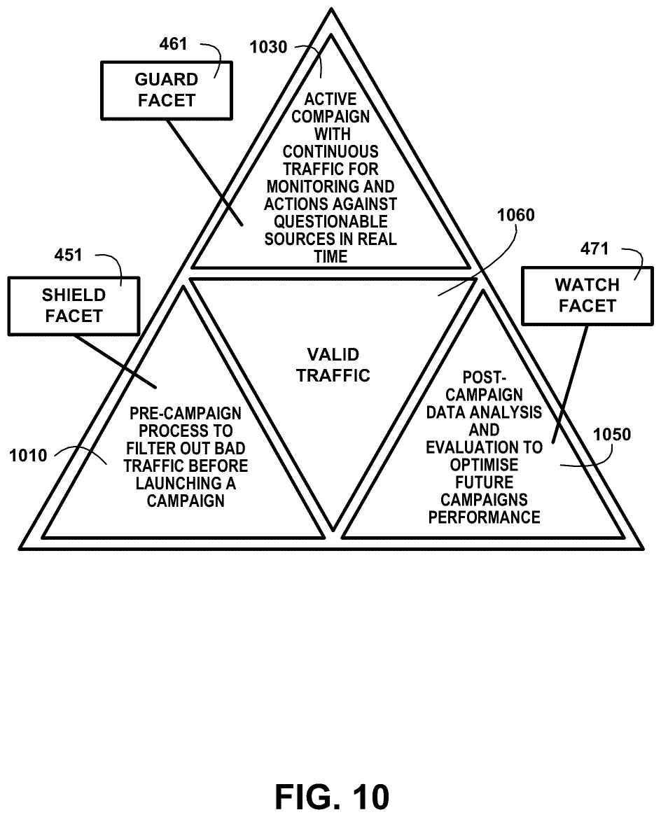

FIG. 10 shows for illustrative purposes only an example of invalid traffic detection facets of one embodiment. FIG. 10 shows invalid traffic detection facets used to detect invalid traffic in three phases of an advertising campaign. A shield facet 451 is used as a pre-campaign process to filter out bad traffic before launching a campaign 1010. A guard facet 461 is used during an active campaign with continuous traffic for monitoring and actions against questionable sources in real-time 1030. A post-campaign data analysis and evaluation process used to optimize future campaigns performance 1050 is the watch facet 471.

All three invalid traffic detection facets are used to prevent invalid traffic in real-time. The preventive steps of each facet will increase the ratio of valid traffic 1060 with database and file management functions to identify and block invalid and fraudulent traffic that increase click costs to the advertiser of one embodiment.

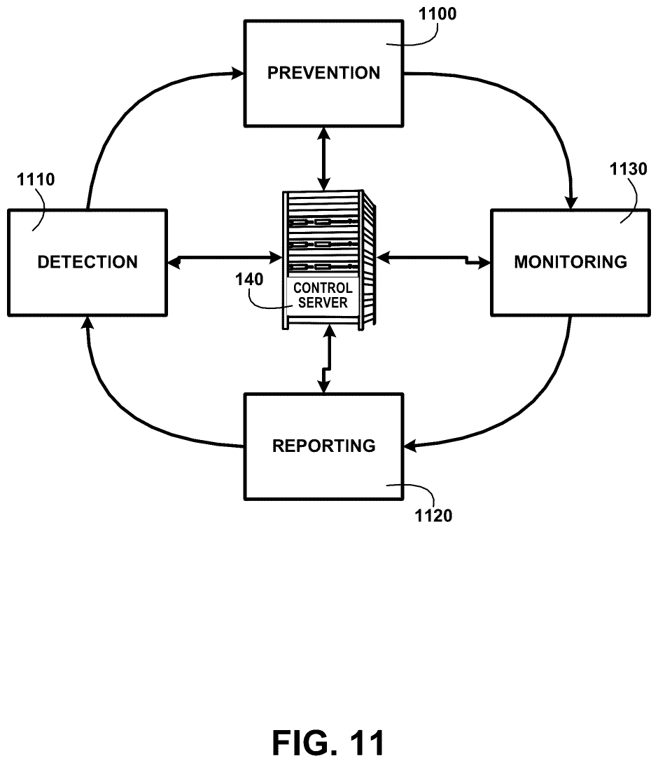

FIG. 11 shows for illustrative purposes only an example of four major sub-systems of one embodiment. FIG. 11 shows the control server 140 with a structure that includes the four major sub-systems of the complementary facets. The four major sub-systems include prevention 1100, detection 1110, reporting 1120, and monitoring 1130 of one embodiment.

A distinctive and unifying feature of the embodiment of the system is the feedback loop that connects advanced analytics and machine learning techniques that the detection subsystem employs at all levels of user engagement to the real-time blocking mechanism of the prevention subsystem that operates at the initial levels of user engagements, such as clicks and impressions.

The monitoring subsystem is, and it is operable, to continuously supply all of the data to support the advanced analytics and machine learning employed by the detection subsystem. The detection subsystem is operable to perform the detection process. Adding the feedback links from each layer of the detection subsystem operating at all levels of a conversion funnel to the prevention subsystem operating at the click level of user engagement. A feedback loop connects the advanced analytics of the detection subsystem with the blocking mechanism of the prevention subsystem in real-time in the system.

The reporting 1120 subsystem includes processes to generate invalid traffic reports and user-given block rules. Another aspect is monitoring 1130 significant changes in partner names and partners' login activities from countries other than the country stated in their registration profile.

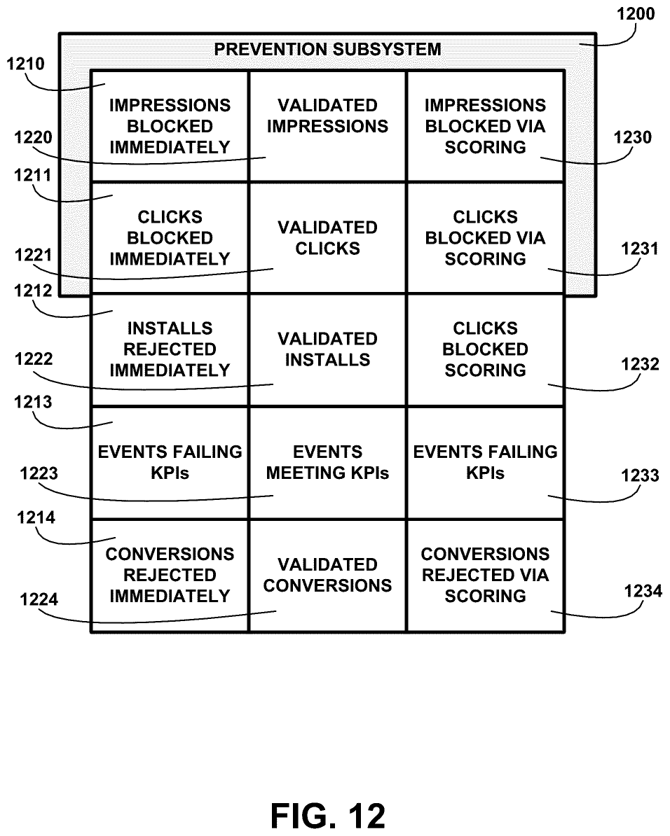

FIG. 12 shows a block diagram of an overview of the prevention subsystem of one embodiment. FIG. 12 shows a prevention subsystem 1200 with processors to check clicks to discover if part actions include impressions blocked immediately 1210, clicks blocked immediately 1211, installs rejected immediately 1212, events failing KPIs 1213, and conversions rejected immediately 1214. The findings would all be negative. The use of KPI refers to Key Performance Indicators (KPI)s which are categories of results.

The prevention subsystem 1200 may find validated impressions 1220, validated clicks 1221, validated installs 1222, events meeting KPIs 1223, and validated conversions 1224. All of these findings would be positive. The findings include processor classifications as impressions blocked via scoring 1230, clicks blocked via scoring 1231, clicks blocked scoring 1232, events failing KPIs 1233, and conversions rejected via scoring 1234 of one embodiment.

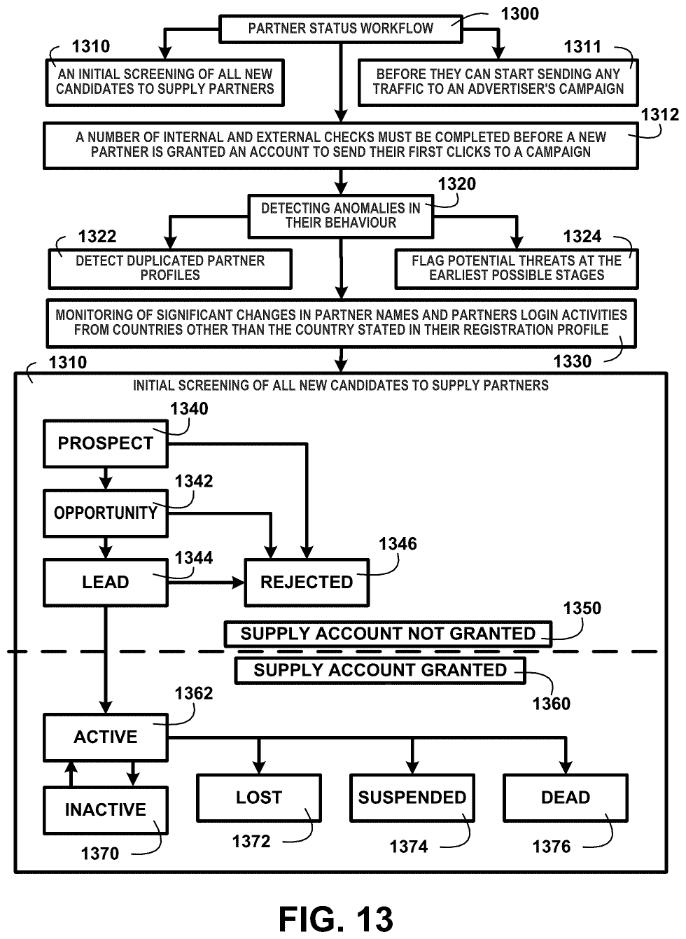

FIG. 13 shows a block diagram of an overview of a partner status workflow of one embodiment. FIG. 13 shows a partner status workflow 1300 to perform an initial screening of all new candidates to supply partners 1310. In this instance, a partner is also referred to as a supplier partner, and a supply partner is an entity that displays the advertiser ads on their website. The partner status workflow 1300 is performed before they can start sending any traffic to an advertiser's campaign 1311, a number of internal and external checks must be completed before a new partner is granted an account to send their first clicks to a campaign 1312. The partner status workflow 1300 uses a processor function for detecting anomalies in their behavior 1320 and detecting duplicated partner profiles 1322. The processor is used to flag potential threats at the earliest possible stages 1324. Another aspect is the monitoring of significant changes in partner names and partners' login activities from countries other than the country stated in their registration profile 1330. In the partner status workflow 1310 a prospect 1340 must provide an opportunity 1342 to generate a lead 1344 and may show rejected 1346 in any of the points being checked. If rejected a supply account not granted 1350 status is assigned to the potential partner.

In another instance a partner may be active 1362 and not inactive 1370, lost 1372, suspended 1374, or considered dead 1376. If none of the negative results are present a supply account granted 1360 status is assigned to the partner of one embodiment.

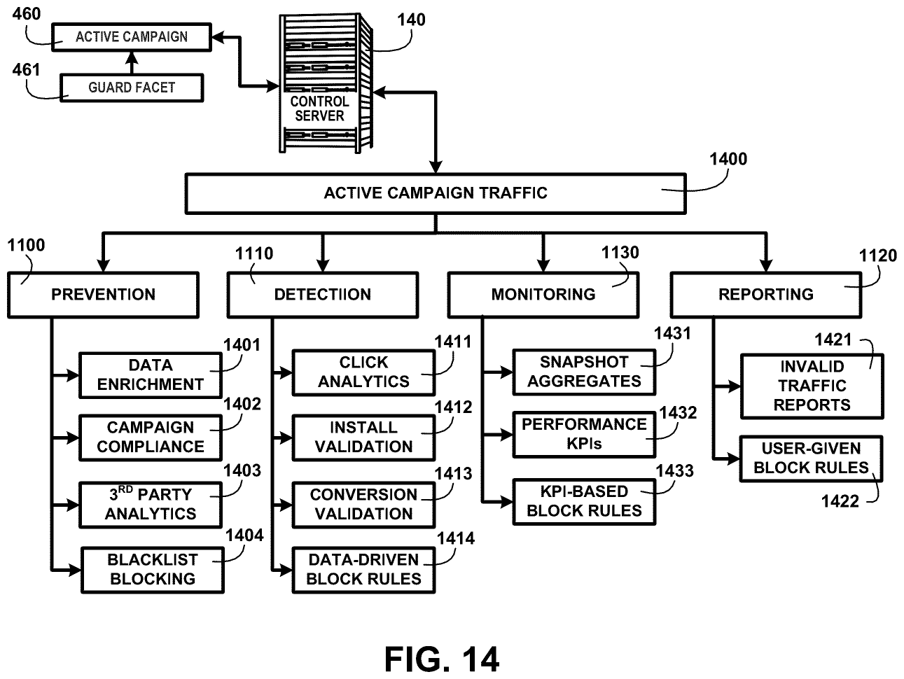

FIG. 14 shows for illustrative purposes only an example of active campaign traffic of one embodiment. FIG. 14 shows an active campaign 460 with the guard facet 461 controller activated in the control server 140. The active campaign traffic 1400 is processed in the prevention 1100 subsystem for data enrichment 1401, campaign compliance 1402, 3rd party analytics 1403, and blacklist blocking 1404. The active campaign traffic 1400 is processed in the detection 1110 subsystem including click analytics 1411, install validation 1412, conversion validation 1413, and data-driven block rules 1414. The monitoring 1130 subsystem is processing the active campaign traffic 1400 including snapshot aggregates 1431, performance KPIs 1432, and KPI-based block rules 1433. Where KPIs are Key Performance Indicators. The reporting 1120 subsystem includes processes to generate invalid traffic reports 1421 and user-given block rules 1422 of one embodiment.

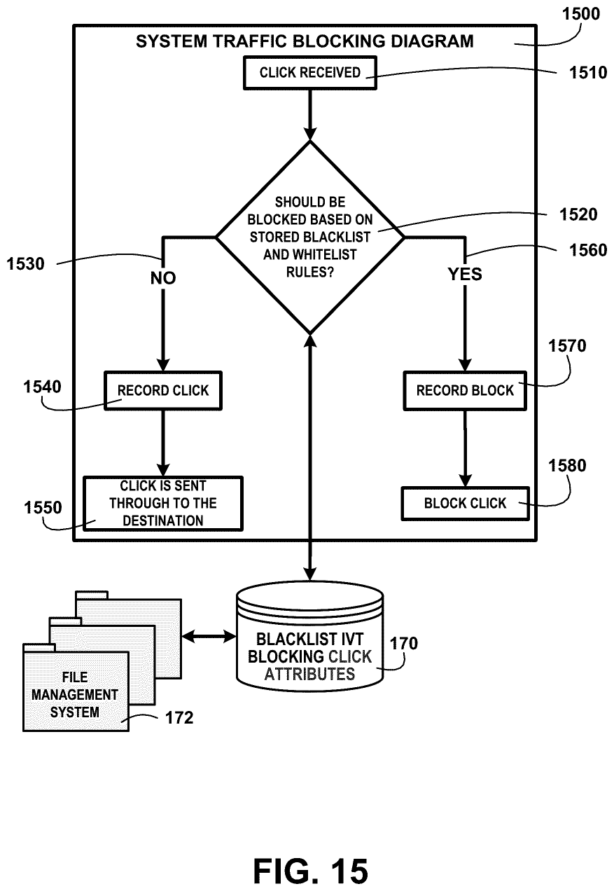

FIG. 15 shows for illustrative purposes only an example of a system traffic-blocking diagram of one embodiment. FIG. 15 shows a system traffic blocking diagram 1500. The system traffic blocking diagram 1500 shows a click received 1510 and the system is used to answer the question if the click should be blocked based on stored blacklist and whitelist rules?1520. The blacklist IVT blocking click attributes 170 database and file management system 172 are queried and the answer comes back no 1530. The system proceeds to record click 1540 and the click is sent through to the destination 1550. The blacklist IVT blocking click attributes 170 database and file management system 172 are queried and the answer comes back yes 1560 then the system will record block 1570 and proceed to block click 1580 in real time to prevent the fraudulent click from being processed of one embodiment.

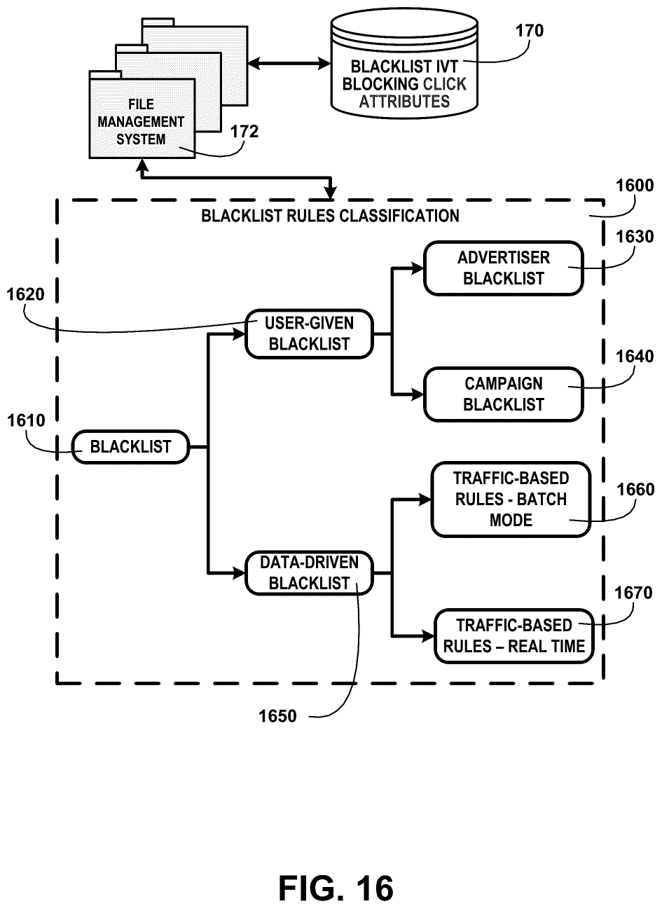

FIG. 16 shows for illustrative purposes only an example of blacklist rules classification of one embodiment. FIG. 16 shows the blacklist IVT blocking click attributes 170 database and file management system 172 used for organizing and storing click attributes. The click attributes are classified within the file management system 172 based on a blacklist rules classification 1600 system. The blacklist 1610 is divided into one part as user-given blacklist 1620, including an advertiser blacklist 1630 and a campaign blacklist 1640. In another part, the blacklist 1610 includes data-driven blacklist 1650 areas including traffic-based rules—batch mode 1660 and traffic-based rules—real time 1670 of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A method for mitigating fraud, the method comprising:
storing on a database, electronic program instructions for controlling a processor of an advertiser server;
generating input data on a local device of at least one selectable advertisement;
transmitting the input data of the local device to the advertiser server in response to the at least one selectable advertisement being selected;
analyzing the input data by comparing current attributes of a source of the input data with known attributes of known sources that include demographic origins and activities of the known sources based on registered profile information of the source to determine if certain behavioral anomalies of the source of the input data exists;
storing in an advertiser database the comparison of the current attributes of the source of the input data and the known sources and the determination if certain behavioral anomalies of the source of the input data exists;
using the stored comparison of the current attributes and the known attributes of the source of the input data and the known sources to detect if the source of the input data originates from at least one malicious source or at least one legitimate source based on an analysis of an existence of the determined certain behavioral anomalies and the comparison of the current attributes and the known attributes;
blocking the selectable advertisement to be transmitted to the advertiser server to prevent access to the selectable advertisement on the local device if it is determined that the source of the input data originates from the at least one malicious source; and
allowing the selectable advertisement to be transmitted to the advertiser server to allow access to the selectable advertisement on the local device if it is determined that the source of the input data originates from the at least one legitimate source.

2. The method for mitigating fraud of claim 1, further comprising using the processor to monitor the certain behavioral anomalies to generate an indication of an at least potentially malicious source of input data of blocking click attributes data status.

3. The method for mitigating fraud of claim 1, further comprising detecting predetermined attributes other than the current attributes of the local device and comparing with known attributes to determine potentially malicious input data of Internet web browsers used by the local device source.

4. The method for mitigating fraud of claim 1, wherein the blocking of the selectable advertisement is performed in real time.

5. The method for mitigating fraud of claim 1, further comprising analyzing the registered profile information for duplicate profile detection and unusual profile changes.

6. The method for mitigating fraud of claim 1, further comprising analyzing the registered profile information for login pattern anomalies.

7. The method for mitigating fraud of claim 1, wherein allowing the selectable advertisement to be transmitted to the advertiser server to allow access to the selectable advertisement on the local device if it is determined that the source of the input data originates from the at least one legitimate source includes displaying the selectable advertisement on the local device.

8. A mitigating fraud system, comprising:
a database having stored electronic program instructions configured to control a processor of an advertiser server;
a local device coupled to the advertiser server configured to generate input data for at least one selectable advertisement, wherein the input data is configured to be wirelessly transmitted to the advertiser server in response to the at least one selectable advertisement being selected;
a processor coupled to the database configured to analyze the plurality of input data by comparing current attributes of a source of the input data with known attributes of known sources that include demographic origins and activities of the known sources based on registered profile information of the source to determine if certain behavioral anomalies of the source of the input data exists;
wherein the processor is coupled to the database and further configured to store in an advertiser database the comparison of the current attributes of the source of the input data and the known sources and the determination if certain behavioral anomalies of the source of the input data exists;
a comparison processor controlled by the electronic program instructions and configured to use the stored comparison of the current attributes and the known attributes of the source of the input data and the known sources to detect if the source of the input data originates from at least one malicious source or at least one legitimate source based on an analysis of an existence of the determined certain behavioral anomalies and the comparison of the current attributes and the known attributes;
a prevention processor controlled by the electronic program instructions and configured to block the selectable advertisement to be transmitted to the advertiser server to prevent access to the selectable advertisement on the local device if it is determined that the source of the input data originates from the at least one malicious source; and
wherein the selectable advertisement is allowed to be transmitted to the advertiser server to allow access to the selectable advertisement on the local device if it is determined that the source of the input data originates from the at least one legitimate source.

9. The mitigating fraud system, of claim 8, wherein the processor is further configured to monitor the certain behavioral anomalies to generate an indication of an at least potentially malicious source of input data of blocking click attributes data status.

10. The mitigating fraud system, of claim 8, wherein the processor is further configured to detect predetermined attributes other than the current attributes of the local device and compare with known attributes to determine potentially malicious input data of Internet web browsers used by the local device source.

11. The mitigating fraud system, of claim 8, wherein the blocking of the selectable advertisement is performed in real time.

12. The mitigating fraud system, of claim 8, wherein the processor is further configured to analyze the registered profile information for duplicate profile detection and unusual profile changes.

13. The mitigating fraud system, of claim 8, wherein the processor is further configured to analyze the registered profile information for login pattern anomalies.

14. The mitigating fraud system, of claim 8, wherein the processor is further configured to display the selectable advertisement on the local device if it is determined that the source of the input data originates from the at least one legitimate source.

15. A mitigating fraud system, comprising:
a database having stored electronic program instructions configured to control a processor of an advertiser server;
a local device coupled to the advertiser server configured to generate input data for at least one selectable advertisement, wherein the input data is configured to be wirelessly transmitted to the advertiser server in response to the at least one selectable advertisement being selected;
a processor coupled to the database configured to analyze the plurality of input data by comparing current attributes of a source of the input data with known attributes of known sources that include demographic origins and activities of the known sources based on registered profile information of the source to determine if certain behavioral anomalies of the source of the input data exists;
wherein the processor is coupled to the database and further configured to store in an advertiser database the comparison of the current attributes of the source of the input data and the known sources and the determination if certain behavioral anomalies of the source of the input data exists;
a comparison processor controlled by the electronic program instructions and configured to use the stored comparison of the current attributes and the known attributes of the source of the input data and the known sources to detect if the source of the input data originates from at least one malicious source or at least one legitimate source based on an analysis of an existence of the determined certain behavioral anomalies and the comparison of the current attributes and the known attributes;
a prevention processor controlled by the electronic program instructions and configured to block the selectable advertisement to be transmitted to the advertiser server to prevent access to the selectable advertisement on the local device if it is determined that the source of the input data originates from the at least one malicious source; and
wherein the selectable advertisement is allowed to be transmitted to the advertiser server to allow access to the selectable advertisement on the local device if it is determined that the source of the input data originates from the at least one legitimate source, and wherein the selectable advertisement is displayed on the local device.

16. The mitigating fraud system, of claim 15, wherein the processor is further configured to monitor the certain behavioral anomalies to generate an indication of an at least potentially malicious source of input data of blocking click attributes data status.

17. The mitigating fraud system, of claim 15, wherein the processor is further configured to detect predetermined attributes other than the current attributes of the local device and compare with known attributes to determine potentially malicious input data of Internet web browsers used by the local device source.

18. The mitigating fraud system, of claim 15, wherein the blocking of the selectable advertisement is performed in real time.

19. The mitigating fraud system, of claim 15, wherein the processor is further configured to analyze the registered profile information for duplicate profile detection and unusual profile changes.

20. The mitigating fraud system, of claim 15, wherein the processor is further configured to analyze the registered profile information for login pattern anomalies.
